(19) United States
(12) Patent Application Publication
(10) Pub. No.: US 2004/0263377 A1
(43) Pub. Date: Dec. 30, 2004

(54) Television remote control systems and methods

(76) Inventors: Christopher P. Risi, Laguna Niguel, CA (US); Michael K. Friedland, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/838,944

(22) Filed: May 4, 2004

Related U.S. Application Data
(63) Continuation-in-part of application No. 09/921,009, filed on Aug. 2, 2001, now abandoned.
(60) Provisional application No. 60/222,563, filed on Aug. 3, 2000.
(60) Provisional application No. 60/263,348, filed on Jan. 22, 2001.

(51) Int. Cl. H04L 17/02; G08C 19/12

(52) U.S. Cl. 341/175

(57) ABSTRACT

A control device includes buttons that depict the logos of various entities, stations, web sites, or the like. For example, a television remote control device includes buttons that depict logos of various television stations or networks. The television remote control device may also include a multi-channel button that may be personalized or programmed to cycle through a group of stations, such as “sister” stations belonging to the same network, with successive selections of the multi-channel button. The control device also provides for voice activation.

### REFERENCE TO RELATED APPLICATION

This application is a continuation-in-part of U.S. patent application Ser. No. 09/921,009, filed on Aug. 2, 2001, which relates to and claims priority from U.S. Provisional Application No. 60/222,563, filed Aug. 3, 2000, and U.S. Provisional Application No. 60/263,348, filed Jan. 22, 2001, all of which are hereby incorporated by reference.

### BACKGROUND OF THE INVENTION

1. Field of the Invention

The systems and methods of the present invention relate generally to the field of television remote controls.

2. Description of the Related Art

Existing television remote controls allow users to enter the number of the channel that corresponds to the television station they wish to view. The television stations and channel numbers may be listed in a television guide or on a chart provided by the local television or cable station.

One common problem with conventional approaches is that users do not always know the number of the channel they wish to view and in many cases may not recall the name of the network that sponsors the television station they wish to view.

Another common problem with conventional approaches is that some users with poor vision may have difficulty looking up a channel number in a television guide or a chart.

### SUMMARY OF THE INVENTION

The present systems and methods provide remote control devices that include buttons that depict the logos of various entities.

For purposes of summarizing the invention, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates an example television remote control with logo buttons.

FIG. 1A illustrates an embodiment of a television remote control with logo buttons and that utilizes one embodiment of voice activation technology.

FIG. 2 illustrates a flow chart of sample button program process.

FIG. 3 illustrates a high-level block diagram of the remote control system.

FIG. 3A illustrates a high-level block diagram of an embodiment of a remote control system that utilizes one embodiment of voice activation technology.

### DETAILED DESCRIPTION OF THE PREFERRED EMBODIMENTS

Systems and methods which represent one embodiment and example application of the invention will now be described with reference to the drawings. Variations to the systems and methods which represent other embodiments will also be described. In one embodiment, the systems and methods are used to provide a television remote control with logo buttons.

For purposes of illustration, one embodiment will be described in the context of a television remote control. The inventor contemplates that the present invention is not limited by the type of control device used, and that a variety of control devices may be used, such as, for example, a radio remote control device, a stereo remote control device, an Internet remote control device, a telephone, a computer keyboard, a personal computing device, a cellular phone, and so forth. The figures and descriptions, however, relate to an embodiment of the invention wherein the remote control device is a television remote control.

It is recognized that in other embodiments, the systems and methods may be implemented using a variety of components. The systems and methods will now be described with reference to the drawings summarized above. The drawings, the associated descriptions, and the specific implementation described herein are provided to illustrate embodiments of the invention, and not to limit the scope of the invention. The scope of the invention is defined by the appended claims and their equivalents.

I. Remote Control with Logo Buttons

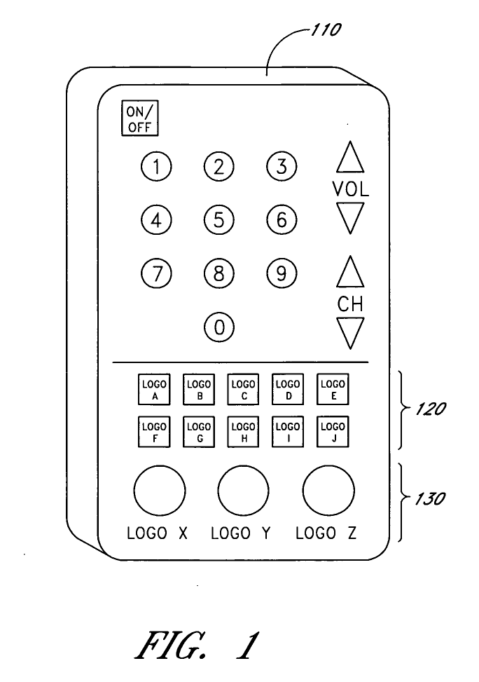

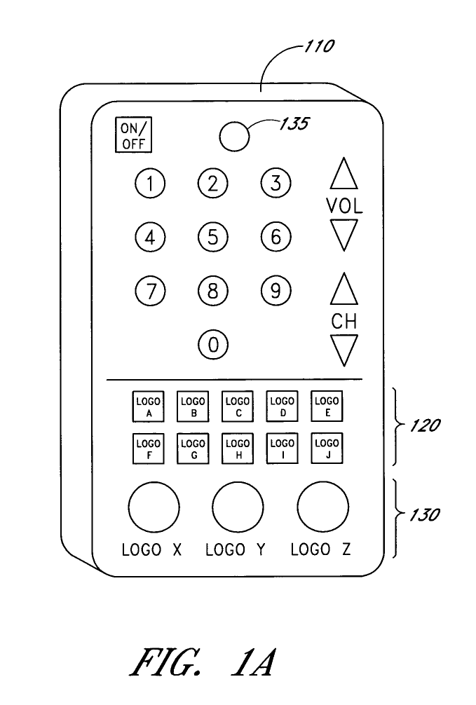

The present systems and methods provide a remote control that includes buttons that depict the logos or marks is illustrated in FIG. 1 of various entities. FIG. 1 illustrates a sample remote control 110 that includes buttons with logos using generic logos, such as, LOGO A, LOGO B, and so forth. In one embodiment, however, the remote control may include the CBS “eye” logo and/or the NBC “peacock” logo. The exemplary remote control also includes traditional buttons such as “ON/OFF,” Volume Control, Channel Up/Down, and numbered buttons to allow the user to enter the numeric designation of channels. The exemplary remote control also includes a set of preprogrammed buttons that depict logos 120 as well as a set of buttons that may be programmable by the user 130 and customized to reflect the networks selected by the user. In other embodiments of the invention, a portion or all of the buttons 120 are not preprogrammed. In such embodiments, the buttons 120 maybe programmed by the user or owner of the remote control 110.

One benefit of having logos on or near the buttons is that users do not have to know the entities or stations that correspond to the logos, but may identify the entities or stations by their logos. In the television remote control example, a user would only need to recognize the logo without having to memorize the channel number of each station. Such benefit is useful not only to home users, but also to users who are away from home. For example, a user on travel in a different state may use the television remote control to watch videos on the Disney station. The user may locate the Disney logo on the television remote control and press the corresponding button without having to look up the channel number of the Disney station in his current location.

The term “station,” as used herein is a broad term and is used in its ordinary sense and comprises any local television station, cable station, satellite television station, and the like, which identifies a video and/or audio signal that is broadcast to a television or similar device, such as a monitor. The term “television station” may be used synonymously with the term “station.” In addition, the channel numbers associated with a particular station, or television station, may vary by geographic location. For example, the channel number for a local television station related to the ABC network may be “3” in one location but may be “7” in a different location.

An additional benefit of one embodiment is that a remote control with logos is easier to use for users with poor vision and/or reading difficulties. For example, a user with vision problems may be able to recognize the CBS “eye” logo even though he may not be able to read the television guide, a channel chart, and/or the number buttons on the television remote control. In addition, children may be able to use the remote control. Parents may program buttons with the Disney logo, the Nickelodeon logo, the Cartoon channel logo, and so forth enabling a child to use the television remote control without having the ability to read and/or recognize station names or channel numbers.

As noted above, in one embodiment, the remote control 110 may include standard buttons 120 that have been preprogrammed. For example, a television remote control may include buttons with logos from popular networks, such as, for example, ABC, CBS, NBC, FOX, CNN, ESPN, VH1, and MTV. It is recognized that a variety of standard buttons may be included and that the above listed networks are only meant to illustrate the feature of having standard buttons 120 and not to limit the scope of the invention. In one embodiment, the standard buttons 120 may be different for different audiences. For example, a children's television remote control may include standard buttons 120 with the Disney logo, the Nickelodeon logo, the Cartoon channel logo, and so forth. A television remote control for movie lovers may include standard buttons 120 with HBO, Cinemax, STAR, and Showtime. In addition, a hotel remote control may include ABC, CBS, NBC, FOX, CNN, ESPN, VH1, MTV, the Disney Channel, Nickelodeon, E!, and the Discovery Channel.

In one embodiment, the remote control 110 may also include user programmable buttons 130. This feature enables the user to program buttons and to add the logos of entities in which the user has an interest. For example, one user may program a television remote control to include buttons with logos from QVC, BET, and CMT, while another user may program in ESPN, Fox Sports West, ESPN2, Sci-Fi Channel, and The Golf Channel. It is recognized that a user may choose a variety of networks to add to the programmable buttons 130 and that the above listed combinations are meant to illustrate the feature of programmable buttons 130 and not to limit the scope of the invention. The television remote control 110 with logo buttons may include a set of various network logos that may be placed on the television remote control after the user has programmed the buttons. These logos may be permanent or may be removable. For example, in one embodiment the logos may be printed on permanent sticker material, removable sticker material, magnetic material, and so forth. In other embodiments, the television remote control may include a window behind which a logo may be displayed.

It is recognized that the remote control 110 may be implemented using a variety of different buttons with different logos. Further, in one embodiment, the remote control 110 with logo buttons may include both standard buttons 120 and programmable buttons 130. It is recognized that in other embodiments, the remote control 110 with logo buttons may only include programmable buttons 130 or may only include standard buttons 120. In other embodiments, the remote control 110 with logo buttons may also include once-only programmable buttons or limited access programmable buttons. In other embodiments of the invention, the remote control 110 may include at least one button that may be used to cycle through a family or group of channels, such as a family of “sister” networks.

The programmable buttons 130 may be password protected such that only users who know the password may program and/or reprogram the programmable buttons 130. For example, if a television remote control 110 with logo buttons is used by a hotel, typically only the hotel management may be able to program the programmable buttons 130. The hotel guests may not be able to program the programmable buttons 130. In other embodiments, however, the hotel guests or certain hotel guests may be able to program one or more of the programmable buttons 130.

II. Button Program Process

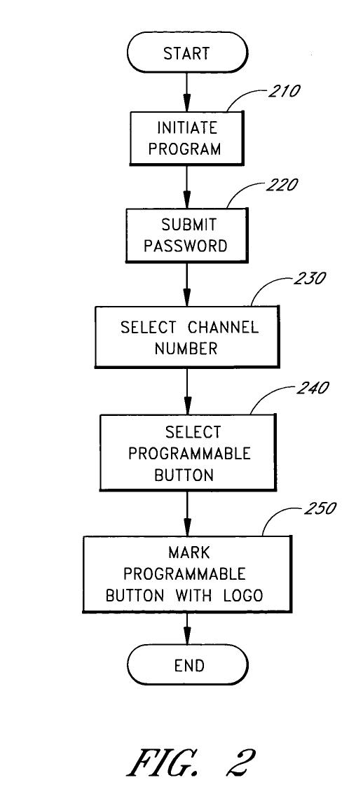

In one embodiment, the remote control 110 may include a button program as shown in FIG. 2. First, a user initiates the program process (block 210), such as, for example, by pressing a “program” button. Next, the user enters his password (block 220). For example, the user may submit a numeric password using the number keys and then press an “enter” button and/or a “password” button. The user then enters the channel number that corresponds to the station the user wishes to store (block 230) and then presses one of the programmable buttons (block 240). It is recognized that the television remote control 110 with logo buttons may include a “program” button, an “enter” button, and/or a “password” button. In other embodiments, the “program” button, “enter” button, and/or “password” button may be other buttons on the remote control (e.g., up channel, down channel, up volume, down volume, etc.). The user may then select a logo to place on the remote (block 250) to designate the newly programmed button. This may include, for example, placing a sticker depicting the logo on or near the button.

It is recognized that FIG. 2 illustrates one embodiment of a button program process and that other embodiments may be used. For example, the remote control 110 may include a touch screen for programming the programmable buttons 130. In addition, the remote control 110 may interface with another device, such as a computer, through which the remote control 110 receives instructions as to how to program the programmable buttons.

In one embodiment, the password may be included with the television remote control 110 with logo buttons and may also include change password instructions on the back of the remote control 110. In other embodiments, the password may be permanent, and/or the change instructions maybe offered as a supplemental instruction sheet, offered via phone instructions, include as a software program, provided by a “help module” and so forth.

In another embodiment, as is depicted in FIG. 1A, the remote control 110 may include voice recognition or voice activation technology in which the user speaks his password, channel selection, and/or programmable button selection. For example, the user may press a voice activation button and speak into a microphone 135 on the remote control 110 the name of a particular network, such as “ABC.” In other embodiments, the user may speak into the microphone 135 without pressing a button. A voice activation circuit of the remote control 110 then causes the television or other display to show that channel associated with the network name spoken by the user. In other embodiments of the invention, other circuitry, modules, or the like may be used to cause the display of the channel associated with the network name spoken by the user. Such modules could include or be implemented as hardware, software, or firmware.

The user may follow a series of steps in order to program the voice activation circuit of the remote control 110. For example, in one embodiment, the user presses the “program” button, presses a voice activation record button, and then speaks the name of the network station to be programmed. The user may then enter the specific channel number associated with the network name and press the “program” button to complete the programming process.

III. Television Remote Control Styles

It is recognized that the remote control 110 illustrated in FIG. 1 illustrates one sample remote control. In other embodiments, the remote control may include other buttons, may include buttons of different shapes and/or sizes, may have the buttons located in different locations on the remote control, and so forth. Further, the remote control may be included as part of another device or unit. For example, the remote control may be embedded in a console in a couch, placed inside a steering wheel of a car, and so forth.

The remote control with logo buttons may be offered in a variety of styles. For example, it may be offered in multiple solid colors (e.g., black, gray, silver, red, pink, blue, etc.), in multiple color combinations (e.g., red/black, white/blue, etc.), in multiple patterns (e.g., leopard pattern, polka dots, etc.), in popular combinations (e.g., a UCLA remote with blue and gold, a USC remote with red and gold, a Laker remote with the Laker logo and in purple and yellow, etc.), or in a variety combinations of the above.

In addition, the remote control with logo buttons may be offered in a variety of sizes. For example, one television remote control with logo buttons may be offered in a small size for hotels with only programmable buttons 130 that may be programmed by management or preprogrammed. Another television remote control with logo buttons may be offered in a larger size for the general public with several standard buttons 120 (preprogrammed with the channel numbers) along with a few programmable buttons 130. In addition, another television remote control with logo buttons may be offered in an extra large size with extra large logo buttons for those users that may have difficulty seeing smaller buttons. A variety of combinations may be used.

In one embodiment, the remote control with logo buttons may also include universal remote buttons for one or more devices, such as, for example, a television, a VCR, a stereo, a compact disk (“CD”) player, a computer, and so forth.

Appendix A provides a set of various remote control styles. Appendix B illustrates a sample chart of potential packages of television remote controls with logo buttons that may be offered for sale.

IV. Remote Control System

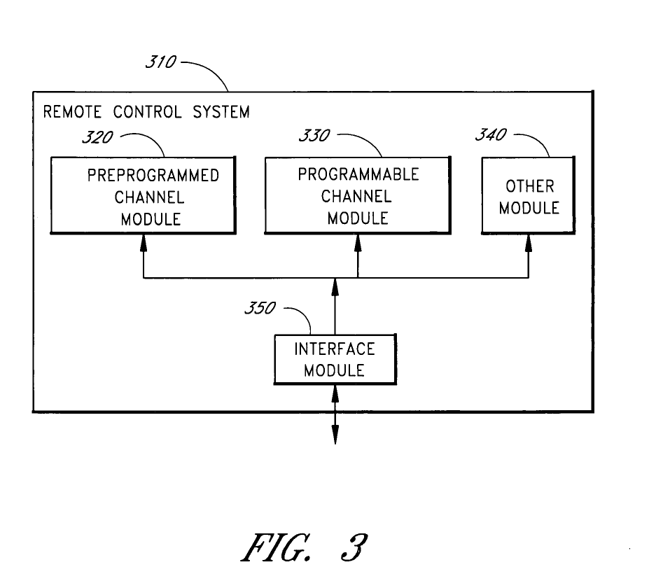

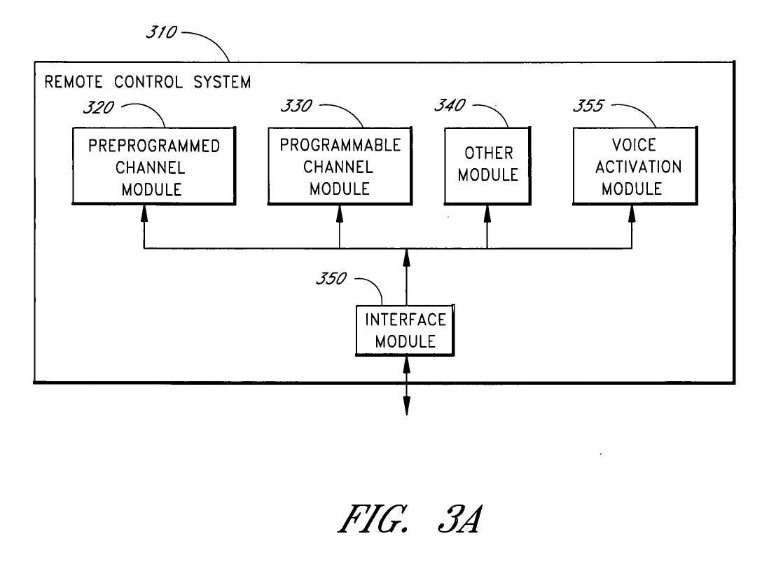

FIG. 3 illustrates a block diagram of one embodiment of a remote control system 310 which may be used to implement the features discussed above. Technology for controlling standard remote controls is well known in the art, however, FIG. 3 shows technology that may be used to implement various embodiments of the remote control with logo buttons.

The exemplary remote control system 310 includes a preprogrammed channel module 320, a programmable channel module 330, and an other module 340 that communicates with an interface module 350. The interface module 350 may interact with the hardware components, devices, and/or drivers that receive user input, such as, for example, the buttons, voice recognition modules, touch screen drivers, and so forth.

The preprogrammed channel module 320 determines how the remote control system 310 responds when a user selects a preprogrammed channel. For example, when a user selects the preprogrammed button with the NBC logo, the preprogrammed channel module 320 changes the television to show the channel that corresponds to the NBC station. In addition, the preprogrammed channel module 320 may interact with other components for setting the preprogrammed channels, such as, for example, a remote control programmer. For example, a hotel may use an external device to program the preprogrammed channels of multiple remote controls.

In another embodiment of the invention, the preprogrammed channel module 320 may be programmed to switch between various channels with successive selections of the same button. In one embodiment, successive selections of the same button may cycle a user through a family of channels or through various “sister” networks. For example, when a user selects the preprogrammed button with the ESPN logo, the preprogrammed channel module 320 changes the television to the channel that corresponds to the ESPN station. If the user selects the preprogrammed ESPN button a second time, the preprogrammed channel module 320 changes the television to the channel that corresponds to the ESPN2 station. If the user selects the preprogrammed ESPN button a third time, the preprogrammed channel module 320 changes the television to the channel that corresponds to the ESPN Classic station. Configuring the preprogrammed channel module 320 to allow for multiple related channels to be accessible by the push of a single button provides for a smaller remote because fewer channel buttons are needed.

Such multi-network family channel access may be preprogrammed or may be programmed by the user through a process similar to the button program processes described previously. For example, the user may set up the first channel by pressing the “program” button, entering the first channel number, and then pressing the channel button with the corresponding network logo. To add a multi-channel functionality to the channel button, the user may press the “program” button twice, enter the second channel number, and press the channel button with the network logo. This process would add the second channel access to the same channel button. This process may also be repeated for adding additional channels to be associated with the same channel button. As a result, each time the user presses the channel button, the multiple related channels would be accessed in the order in which they were programmed. It is recognized that above description is one method of programming multi-channel access and that other methods may be also be used in such programming.

In one embodiment, accessing multiple related channels occurs when a single channel button is pressed multiple times successively without pressing another button. In another embodiment, accessing multiple related channels occurs when a single channel button is pressed multiple times, even if the user presses another channel button during the process. In yet another embodiment, multi-channel functionality is engaged only if the appropriate channel button is pressed multiple times within a set time frame, such as ten seconds. It is also recognized that other time frames may be used.

In another embodiment of the invention, the multi-channel or multi-station button may be used to cycle through a group of related channels regardless of how much time passes between each time the multi-station button is actuated. For example, in one embodiment, the last station accessed by the multi-station button is stored in a memory (not shown) of the remote control 110. The next time the multi-station button is pressed, the next channel in the group of related channels is accessed. Other embodiments may use other techniques, methods, software, or hardware that keep track of the last channel accessed by the multi-station button.

It is contemplated that in other embodiments of the invention the multi-channel button may be configured to cycle through multiple stations that are not related or that are not of the same network family. For example, the multi-channel button may be programmed to cycle through a set of favorite stations that are personalized to a particular user. These personalized stations may be preprogrammed or may be programmed by the user. For example, a multi-channel button personalized for a particular child could be configured to cycle through a group of stations that normally broadcast content directed to children. In another embodiment of the invention, the multi-channel button may configured to cycle through stations that generally broadcast similar types of content, such as news (e.g., CNN, MSNBC, Fox News Channel) or sports (e.g., ESPN, ESPN2, Fox Sports West). In other embodiments of the invention, multiple multi-channel buttons are provided on a single remote to allow for the personalization of multiple groups of stations.

The programmable channel module 330 determines how the remote control system 310 responds when a user selects a programmable channel button. For example, when a user selects the programmed programmable button with the Golf Channel logo, the programmable channel module 330 changes the television to show the channel that corresponds to the Golf Channel station. In addition, the programmable channel module 330 may interact with other components for setting the programmable channels, receiving, and/or verifying password information, and so forth.

The other module 340 may be used to implement other parts of the remote control that are well known in the art, such as, for example, volume control, numeric button selections, channel up/down, and so forth.

The interface module 350 interacts with the hardware components, devices and/or drivers of the remote control to receive input from the user via the buttons, as well as other interface technology, such as voice recognition modules, touch screens, and so forth.

While the preprogrammed channel module 320, the programmable channel module 330, the other module 340, and the interface module 350 are illustrated as separate modules, it is recognized that one or more of the modules may be combined and/or one or more of the modules may be broken down into multiple modules. For example, FIG. 3A depicts an embodiment of the invention that uses voice activation technology. The remote control system 310 of FIG. 3A includes the preprogrammed channel module 320, the programmable channel module 330, the other module 340, and a voice activation module 355 that communicate with the interface module 350.

Further, as used herein, the word module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as hardware modules, but may be represented in software.

As noted above, while many of the above examples reference a television remote control, the present invention is not limited by the type of control device used. Moreover, the types of control devices may include, for example, a radio remote control device with logo buttons. For example, the radio remote control device may include buttons with logos of various radio stations. In one embodiment of the invention, the radio remote control device includes buttons with the call letters (e.g., “NPR”) or station numbers of various stations.

In other embodiments of the invention, the control device may comprise a stereo remote control device with logo buttons. For example, the buttons may include logos of particular radio stations, as described above, or may include logos that correspond to a particular band (e.g., “U2”) or particular music album. In other embodiments, the stereo remote control device may include logos of favorite CDs or other media.

In yet other embodiments of the invention, the control device may comprise an Internet remote control device with logo buttons that include logos of internet web sites (e.g., “CNN”), favorite search engines (“Google”), or companies with web sites or intranet sites.

It is also contemplated that the control device having personalized logos need not be limited to remote control devices. In one embodiment of the invention, the control device may comprise a telephone or a cellular phone with logo buttons. For example, the telephone buttons may include logos of fast food delivery companies (e.g., “Pizza Hut”), restaurants (e.g., “Taco Bell”), service repair companies, utility companies, frequently-called numbers, children's schools, car dealerships, driving instruction company, AAA, and the like.

In other embodiments of the invention the control device may comprise a computer keyboard or a personal computing device, such as a personal data assistant (“PDA”), with logo buttons. For example, the keyboard or personal computing device may comprise buttons with logos of Internet web sites, service repair companies, favorite stock quote sources, favorite search engines, or other frequently-visited or personalized web sites or file locations. In yet other embodiments of the invention, the control device may comprise a combination of any of the control devices described herein.

While certain embodiments of the invention have been described, these embodiments have been presented by way of example only and are not intended to limit the scope of the present invention. Accordingly, the breadth and scope of the present invention should be defined in accordance with the following claims and their equivalents.

What is claimed is:

1. A remote control device comprising:
a plurality of station buttons programmed to select television stations, wherein said station buttons depict logos of said corresponding television stations;
a multi-station button programmed to cycle through multiple related television stations; and
a voice activation circuit programmed to select a television station that is verbally identified by a user.

2. The remote control device of claim 1, wherein said multi-station button selects a first related television station upon being actuated a first time and selects a second related television station upon being actuated a second time.

3. The remote control device of claim 1, wherein the act of actuating said multi-station button the second time must occur within a set time after the act of actuating said multi-station button the first time.

4. The remote control device of claim 1, wherein said multiple related television stations correspond to a family of channels.

5. The remote control device of claim 1, wherein said multiple related television stations correspond to stations of sister networks.

6. The remote control device of claim 1, wherein said multi-station button is programmed by the user.

7. The remote control device of claim 6, wherein programming by the user comprises:
initiating a programming program;
submitting a numeric channel selection for a first related television station; and
submitting a numeric channel selection for a second related television station.

8. The remote control device of claim 1, wherein the multi-station button depicts a logo of the corresponding multiple related television stations.

9. A television remote control device comprising:
a multi-station button programmed to select from multiple related television stations such that the multi-station button is programmed to select a first related television station upon being pressed a first time and is programmed to select a second related television station upon being pressed a second time, wherein said first related television station is different than said second related television station, and wherein said multi-station button depicts a logo of the corresponding multiple related television stations.

10. The television remote control device of claim 9 further comprising a plurality of station buttons programmed to select television stations, wherein said station buttons depict logos of the corresponding television stations.

11. The television remote control device of claim 9, wherein the multi-station button is programmed to select a third related television station upon being pressed a third time, wherein said third related television station is different than said second related television station.

12. The television remote control device of claim 9, wherein said multiple related television stations correspond to a family of channels.

13. The television remote control device of claim 9, wherein said multiple related television stations correspond to sister network stations.

14. The television remote control device of claim 9, wherein said multiple related television stations correspond to stations that broadcast similar types of content.

15. The television remote control device of claim 14, wherein said multiple related television stations correspond to stations that broadcast primarily sports content.

16. A control device configured to access information such as sound, video, graphics or text, the control device comprising:
an interface that corresponds to at least one logo of a source of information; and
a voice activation circuit programmed to select a source of information that is verbally identified by a user.

17. The control device of claim 16, wherein said interface comprises at least one button.

18. The control device of claim 16, wherein said interface comprises a touch screen.

19. The control device of claim 16 further comprising a microphone configured to receive verbal communications from the user.

20. The control device of claim 16 further comprising a multi-station interface that is programmed to select from multiple related sources of information upon successive selections of said multi-station interface.
